(19) United States
(12) Patent Application Publication
(10) Pub. No.: US 2014/0195271 A1
(43) Pub. Date: Jul. 10, 2014

(54) COMBINED ANNUITY AND LIFE INSURANCE METHOD AND SYSTEM

(71) Applicant: FRANK MARTIN SEXTON, Sandy Springs, GA (US)

(72) Inventor: FRANK MARTIN SEXTON, Sandy Springs, GA (US)

(21) Appl. No.: 13/734,995

(22) Filed: Jan. 6, 2013

(51) Int. Cl. G06Q 40/06; G06Q 40/08

(52) U.S. Cl. CPC G06Q 40/06; G06Q 40/08
USPC 705/4

(57) ABSTRACT

An interconnected deferred equity indexed annuity policy and a fixed, variable or equity indexed universal life insurance policy, or variable life insurance policy, method and system where a computer periodically transfers annuity investment gains, if any, and the gains are transformed into premiums for the life insurance policy. Further growth of the transformed annuity policy gains as well as life insurance gains in the life insurance policy is tax-free as long as the involved insurance company observes the requirements of the Internal Revenue Code. Having the annuity policy gains loaned from the annuity policy owner to the life insurance owner, and disproportionately allocating fees from the life insurance policy to the annuity policy derive additional benefits.

### FIELD OF THE INVENTION

The present invention relates generally to a system and method for maximizing annuity investment gains using life insurance and, more particularly, to a system and method for maximizing annuity investment gains using life insurance by periodically using the investment gains from the annuity to buy life insurance.

### BACKGROUND OF THE INVENTION

Generally, deferred annuities are contracts that incorporate investment gains without being subject to immediate federal income tax; however, once the gains are distributed federal income tax must be paid. Life insurance death proceeds are not subject to federal income tax. Certain earlier schemes have tried to avoid this annuity related income tax by taking the gains of an annuity and using the gains to purchase life insurance. For example, in 2005, U.S. Pat. No. 6,950,805 issued to Kavanugh for a “System For Funding, Analyzing And Managing Life Insurance Policies Funded With Annuities” and purports to disclose a complicated system for combining life insurance and annuities, including borrowing money from a lender, purchasing an annuity and a life insurance policy using the borrowed money, paying premiums for the life insurance policy using income from the annuity, making periodic payments on the borrowed money using income from the annuity, and managing tax consequences of the income within an investment trust. The plan requires an immediate annuity contract with a life insurance company that pays an immediate guaranteed income stream for a period of time; however, there is a need for “life only” immediate annuities and that these are not to resemble deferred annuities, although no explanation is given.

In one embodiment, Kavanugh has the annuity purchased by the life insurance policy as an internal investment of the life insurance policy although this approach seems to contradict what was mentioned earlier in the patent. In another embodiment the internal investment is administered through a “unique trust,” a business entity or a partnership agreement. The disadvantage of such a system, however, is that substantial mortality expenses are incurred by the life insurance policy from the time the life policy is purchased until the insured dies.

In 2008, U.S. Pat. No. 7,343,333 issued to Menke for a “Method And System For Converting An Annuity Fund To A Life Insurance Policy” and purports to disclose a system for converting an annuity to a life insurance policy at a predetermined future conversion date. This system reduces mortality expenses by purchasing the life insurance at a later date closer to the death of the life policy owner; however, the system has the disadvantage of not providing a death benefit in the event of a sudden death prior to the conversion date.

### SUMMARY OF THE INVENTION

In accordance with the present invention, an advantageous method and system are described in the form of an interconnected annuity contract and life insurance contract in which investment gains in a deferred annuity contract are used periodically to purchase life insurance. The plan achieves the desire to avoid federal income and other taxes in a simple and efficient manner and thereby maximize investment gains from the annuity. With one or more computers the necessary tracking, computations, transfers and comparisons are accomplished easily and safely.

Briefly summarized, the invention relates to a computer implemented method for forming an annuity and life insurance product including the steps of selecting an annuity policy, selecting a life insurance policy, selecting annuity data, including one or more of the following: selecting an annuity fund deposit amount, selecting an annuity owner, selecting an annuity beneficiary, selecting an annuitant, and selecting an annuity investment option, selecting life insurance data, including selecting a policy owner, selecting an insured individual, and selecting a policy beneficiary, entering the annuity policy selection, the life insurance policy selection, the annuity data, the life insurance data, and life insurance regulatory requirements into a data processing apparatus, the data processing apparatus having storage, processing and display elements, calculating investment gains from the annuity policy, at periodic intervals using the investment gains to purchase the life insurance policy, at periodic intervals calculating life insurance death benefit and cash value amounts, and at periodic intervals displaying the life insurance death benefit and cash value amounts.

The invention also relates to a data processing system for processing data associated with an annuity product including an annuity contract and a life insurance contract, the data processing system including a storage device for storing data relating to the annuity contract and to the life insurance contract, and annuity and life insurance data including an annuity owner, an annuity beneficiary, an annuitant, an annuity fund deposit amount, an annuity investment option, an annuity management fee, an investment index, an annuity loan rate, an insurance contract owner, an insured individual, an insurance contract beneficiary, a life insurance policy fee, a cost of insurance data, and an annuity investment gain, a processor in communication with the storage device, the processor configured to: calculate expenses attributed to the product, calculate a value of the annuity contract at a first predetermined date, calculate a net annuity investment gain over a predetermined period, calculate a value of the annuity contract at a second predetermined date, transfer the net annuity investment gain, if any, from the annuity contract to the life insurance owner, purchase life insurance with the amount of net annuity investment gain, responsive to the purchase of life insurance calculate death benefit and cash value amounts of the insurance contract, store data relating to the values of the annuity contract, store data relating to the amounts of the life insurance contract, and display, print and/or store preselected data relating to the annuity values and the insurance amounts.

### BRIEF DESCRIPTION OF THE DRAWINGS

For the purpose of facilitating an understanding of the invention, the accompanying drawings and detailed description illustrate embodiments thereof, from which the structures, construction and operation, processes, and many related advantages of the embodiment may be readily understood and appreciated.

FIG. 1 is a flow diagram of the inventive method for an annuity portion of a combined annuity and life insurance product as described below.

FIG. 2 is a flow diagram of the inventive method for a life insurance portion of the combined annuity and life insurance product as described below.

FIG. 3 is a chart showing operation of a hypothetical annuity and life insurance product in accordance with the invention herein.

FIG. 4 is a flow diagram of a data processing system for the interconnected annuity and life insurance product.

### DESCRIPTION OF THE EMBODIMENTS

The following description is provided to enable those skilled in the art to make and use the described embodiments set forth. Various modifications, equivalents, variations, and alternatives, however, will remain readily apparent to those skilled in the art. Any and all such modifications, variations, equivalents, and alternatives are intended to fall within the spirit and scope of the present invention defined by the below listed claims.

The present invention requires the use of both, annuity and life insurance contracts or policies. The terms “contract” and “policy” are used interchangeably herein. Life insurance is a contract between an insurance policy owner and an insurer, typically an insurance company, where the insurer promises to a pay a designated beneficiary a sum of money, the benefits, upon the death of an insured person. The life insurance beneficiary receives the benefits free of federal income tax. An annuity is also an insurance policy, which in exchange for a sum of money from an annuity owner, an issuer, typically an insurance company, guarantees that the issuer will make a series of payments to a designated person, the annuitant. Most annuities are savings instruments designed to first accumulate funds and then systematically to liquidate the funds, usually during annuitant's retirement years. The annuitant and the annuity owner are typically the same individual, but may be different individuals or entities.

A deferred annuity provides for the accumulation of funds to be applied at some future time designated by the annuity or contract owner to supply income for the owner based on the age of the annuitant. Interest credited on the cash values of personally owned annuities is not taxable to the contract owner as long as it remains on deposit with the insurance company. On liquidation, however, annuity payments to a beneficiary are taxable as ordinary income to the extent that each payment represents previously untaxed income. An equity-indexed annuity is a contract whose interest is linked to an equity index, typically the S&P 500.

A preferred life insurance policy for use in the inventive product is a fixed, variable or equity indexed universal life insurance policy or a variable life insurance policy. Universal life insurance policies (UL) are flexible-premium, adjustable-death benefit, unbundled life contracts, and are transparent in operation. A prospective purchaser can see how policy elements, such as premiums, death benefits, interest credits, mortality charges, expenses, and cash values, interact. A key element is that cash values and pure insurance amounts are shown separately. The net amount at risk plus the cash value produce the total policy death benefits. Indexed UL policies provide that interest based on an outside economic indicator, such as the S&P 500, subject to caps, floors and participation rates of the insurance company, are credited to the policy account. There is greater upside interest earnings potential than fixed UL products. There is also an interest floor of at least 0%, which eliminates the downside risk of insurance owner losing money.

Variable life insurance is a type of universal life insurance whose values may vary directly with the performance of a set of earmarked investments, such as the S&P 500, with a view that the policy may help offset the adverse effects of inflation. In such policies, premiums, less an expense or sales load and mortality charge, are paid into a separate investment account. The policy owner may specify, within limits, where the assets backing the cash value are to be invested. There is a greater upside interest earning potential than indexed UL policies, but also greater downside risk. Variable life insurance does not have an interest rate floor so there is a greater downside risk of losing portions of premium investments.

The present invention includes the use of investment earnings or gains of a fixed, variable or equity indexed deferred annuity to provide a tax-free increasing death benefit life insurance policy or policies while incurring a minimal amount of mortality expense. In one embodiment, the method and system utilize the funds from the deferred annuity contract to invest in income producing assets and then use the periodic earnings or gains from those assets to purchase one or more life insurance contracts that have the minimum amount of pure death benefits as required by Section 7702 of the Internal Revenue Code (IRC) and meet the Guideline Single Premium (GSP) requirements as statutorily mandated. The present invention provides an immediate and increasing death benefit at a minimal mortality cost, while maintaining the tax advantages for the investment gains of the annuity policy and the non-tax status of death proceeds from the life insurance policy.

Section 7702 of the IRC provides a requirement to be met if the life insurance policy is to be accorded favorable tax treatment. In order for policy death benefits to qualify as life insurance it must meet the criteria of either of the following tests. The first test applies mainly to traditional cash-value policies. This cash-value accumulation test (CVAT) requires that by the terms of a contract the cash surrender value cannot at any time exceed the net single premium required to fund future contract benefits. The net single premium is calculated by assuming an interest rate equal to the greater of four percent or the rate guaranteed in the contract, or if not specified, the morality charges used in determining statutory reserves for that contract. The second test requires that both a guideline premium and a death benefit requirement be met. The guideline premium requirement is met if the cumulative premiums paid under a contract do not exceed, at any time, the greater of the Guideline Single Premium or the sum of the Guideline Level Premium (GLP) at that time. The total premiums paid must be less than the greater of the GSP or the GLP times the number of years.

The Guideline Single Premium is computed using interest at the greater rate of six percent or the rate guaranteed in the contract. Mortality charges are based on the same standard as applies to the cash-value accumulation test. The Guideline Level Premium is computed in a manner similar to the computing of the Guideline Single Premium, except that the minimum interest rate is four percent rather than six percent. The death benefit requirement is met if death benefits exceed two hundred fifty percent of the cash value for an insured of attained age up to forty, grading down to one hundred percent of the cash value at attained age ninety-five. There are computational rules for the preceding tests, called corridor requirements. For one, any future net amount at risk cannot exceed the net amount at risk existing when the policy was issued. In addition, when future policy benefits are changed, such as a scheduled change in death benefits or the purchase of paid-up additions, a new calculation must be made to determine whether the policy continues to qualify as life insurance. The corridor requirement, account value times the corridor factor must be less than the death benefit. To prevent a violation of the corridor requirement, the death benefit will automatically increase when necessary.

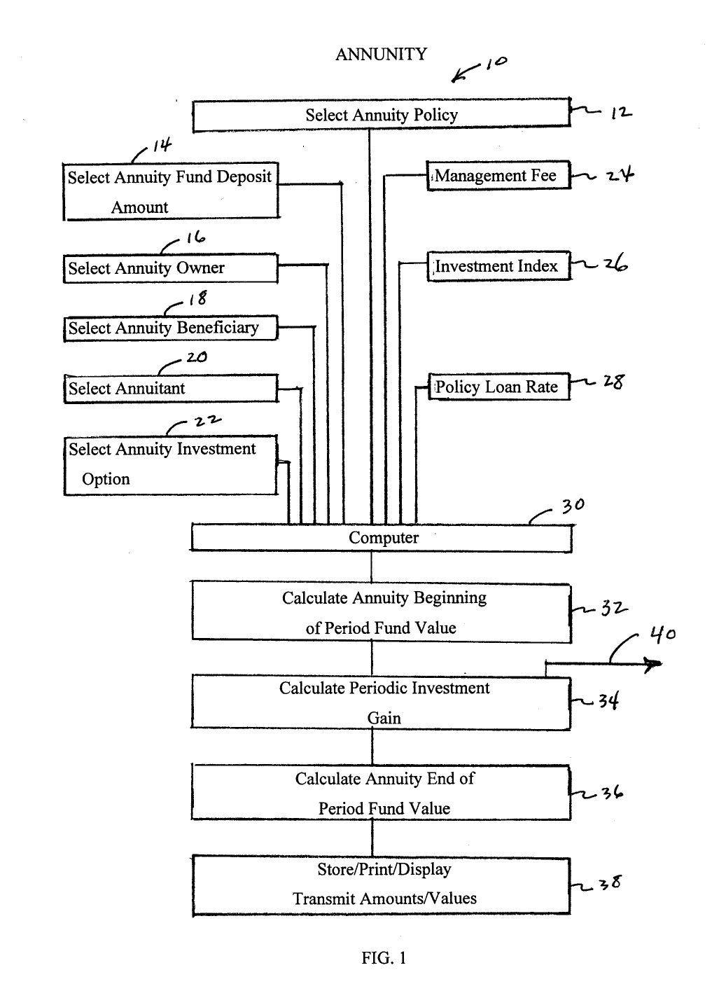

Referring now to FIG. 1, there is illustrated a flow chart 10 of a computer implemented method for forming and maintaining an annuity contract component of the disclosed annuity and life insurance product. At inception, the annuity owner selects the annuity policy 12, preferably a deferred equity indexed annuity. An individual buyer then selects certain data, such as an annuity fund deposit amount 14, an annuity owner 16, an annuity beneficiary 18, an annuitant 20, and an annuity investment option 22, such as bonds, the S&P 500, or the like. An insurance company, with whom the individual makes the contract and to whom the deposit amount 14 is paid, determines a management fee 24, an investment index 26 and a policy loan rate 28. The investment index 26 is what the annuity funds or insurance cash values are invested in. The policy loan rate 28 is the interest, if any, charged on money loaned to the insurance policy owner by the annuity owner as will be explained below. The annuity policy choice and annuity related data are entered into a computer 30, the computer having a memory/storage and a processor. The computer calculates the value of the annuity fund 32 at a first predetermined date, such as the date of the fund deposit, assumed here to be January first, calculates the investment gain 34 after a predetermined time period, such as a year, a quarter or a month, or any other convenient time period, and at a second predetermined date, such as the following December thirty-first, calculates the annuity end of period fund value 36. The computer and/or peripheral equipment stores, prints, displays and/or transmits amounts/values 38 that have been calculated.

Annuities and their marketability are the primary focus of the method and system here. Annuities are products that are offered by many insurance companies in competition with other insurance companies. What is described in detail here is a method and system enhancement to further the objective of annuity owners and present a more marketable product for insurance companies. The objective of annuity owners is to have an investment grow tax-free and not become a tax liability until the annuity growth or gain is distributed, typically after retirement when the owner may be in a lower tax bracket. In the inventive method and system, not only is income tax deferred with the use of the annuity, but with the addition of a life insurance policy as a component of the method and system, it becomes possible to avoid income taxes altogether on a large portion of the investment gains initially generated by the annuity policy.

The tax avoidance advantage is accomplished by periodically transforming the annuity investment gains into premiums for a life insurance policy. Further growth of the transformed gains in the life insurance policy is tax-free as long as the insurance company observes the requirements of the Internal Revenue Code for life insurance. Therefore, the computer 30 (or computers) not only track the investment gains in the annuity and the life insurance policies but the computer/computers track the insurance portion of the product to ensure that the life insurance policy or policies continuously meet the IRC. If a policy fails to meet the IRC definition of life insurance at any time, the policy is not given favorable tax treatment. To enhance the method and system further, when the annuity investment gain is loaned to the life insurance owner to pay the life insurance premium the income tax that would normally have to be paid when the transformation takes place, because the event is considered a distribution, is deferred until the loan is repaid and the annuity is distributed, typically at the death of the annuitant.

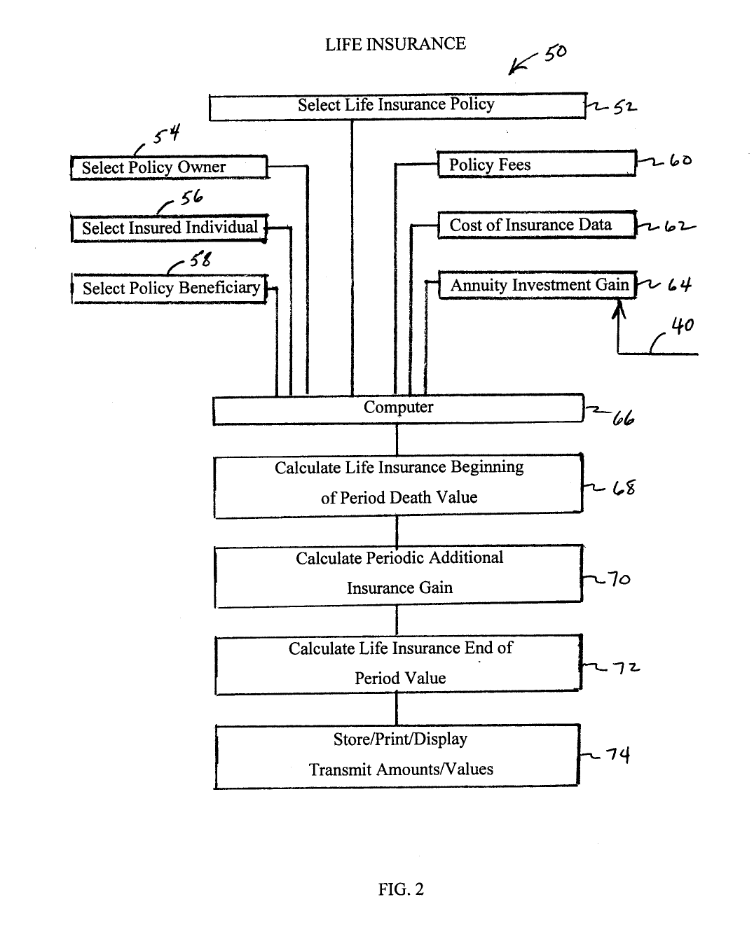

The annuity investment gain 34 is transferred, as symbolized by arrows 40, FIGS. 1 and 2, to a life insurance policy component of the inventive method and system as illustrated in a flow chart 50, FIG. 2. The individual or entity buying the product selects a life insurance policy 52, such as a fixed, variable or equity indexed universal life insurance policy. Next, a policy owner 54, an insured individual 56, and a policy beneficiary 58 are selected. The insurance company adds its policy fee 60, its cost for collecting insurance data 62, and the transferred annuity investment gain 64, symbolized by the arrow 40, and now transformed into a life insurance premium. The cost of insurance data 62 is the pure life insurance cost of a life policy, the death benefit minus the cash value times the insurance company's charge, usually expressed in dollars per 1000. The insurance company has a different cost structure for each age and each underwriting class, for male and female. The data is the pure death benefit charge for each age for each underwriting class.

All of the abovementioned insurance related data is entered into a computer 66, which may be the earlier mentioned computer 30, FIG. 1. The computer calculates the beginning death value of the life insurance at a first predetermined date 68, likely to be the same date, such as December thirty-first, or shortly thereafter, as the date that the annuity investment gain 40 is transferred. After another predetermined time period, such as the end of the following year, quarter or month, the computer or computers calculate the additional insurance gain 70, and then the life insurance end of period cash value and death benefit 72. The insurance gain is tax-free by IRC definition. The computer and/or peripheral equipment stores, prints, displays and/or transmits amounts/values 74.

The annuity gain transfer 40 is a taxable event at the time of transfer, unless it is made in the form of a loan from the annuity policy owner to the life insurance policy owner as mentioned above. A loan is advantageous for the preferred method and system because a loan defers the tax on the transferred annuity gain. The loan will be repaid from death proceeds or from the surrender value of the life insurance contract at some future date, and at the time of repayment the annuity beneficiary will pay a tax on the gains from the annuity. Statutory requirements may necessitate a nominal interest rate to be applied to the loan, although if a State has no such requirement, a zero percent rate is preferable so that more funds remain in the insurance contract and are distributed tax free.

The advantage of the disclosed method and system is that by using gains from a tax-deferred annuity to fund life insurance, typically on an annual basis, investment growth occurs mostly tax-free in the life insurance policy. Even though taxes may be paid on the periodic annuity gains, or, if the annuity gains are loaned to fund the life insurance policy such that the tax is deferred, once transferred, future growth occurs only in the life insurance policy, tax-free. The gains from the annuity may be transferred yearly, quarterly or monthly or on any other convenient schedule.

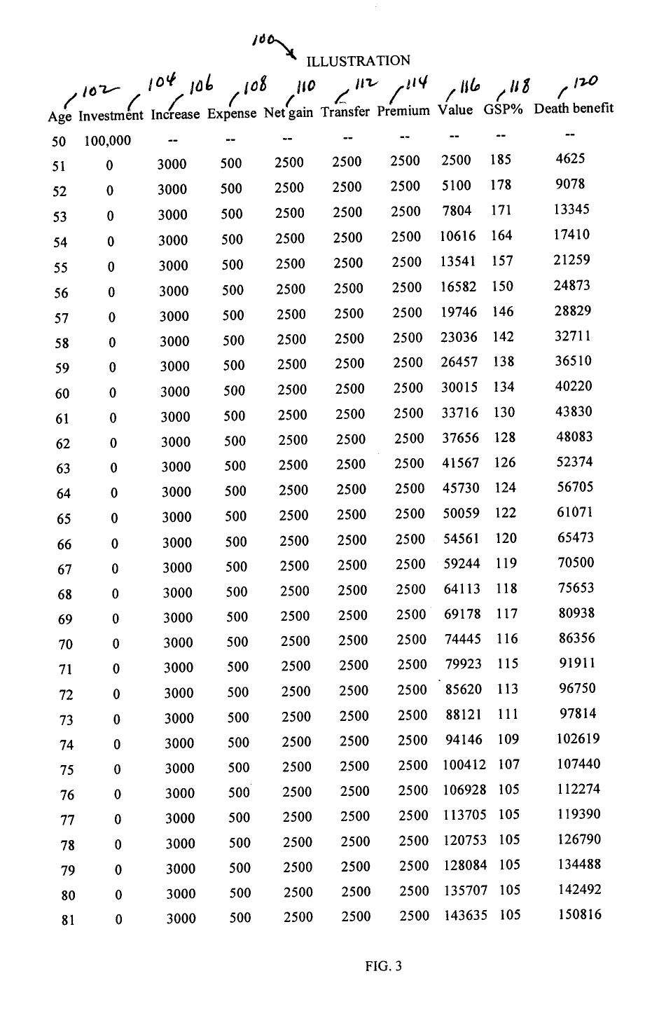

Referring now to FIG. 3, a chart 100 of the operation of a hypothetical annuity and life insurance product according to the present invention is illustrated for a fifty year old purchaser of the proposed package where annuity gains are loaned at zero interest to the life insurance policy owner, who may also be the annuity owner, to pay annual premiums on a life insurance policy. The chart 100 assumes, for simplicity here, that the annuity investment option is invested in a thirty-year bond at three percent that nets two and a half percent after expenses for the annuity policy and a rider for the life insurance policy. As mentioned hereinabove, the annuity investment may be invested in other investment vehicles, such as a portfolio of equities or the S&P 500, all of which necessitates the use of a computer to track numerous and continuing value changes. The chart also assumes a disproportionate allocation of life insurance policy fees and expenses against the annuity policy so as to again maximize investment growth in the life insurance policy.

The age period of the insured life is from fifty years old to eighty-one years old, and is shown in a first column 102, and the yearly investment in the annuity is set forth in a second column 104, showing an initial investment of $100,000, but no further investments, although further investments may be made. The gross annual gain in the annuity is $3000, which is the bond at three percent on a principle of $100,000, and that gain is shown in a third column 106. An annuity/life insurance expense of $500 is assumed and is shown in a fourth column 108. The net annual gain of the annuity is shown in a fifth column 110, the amount transferred from the annuity policy to the life insurance policy is shown in a sixth column 112, and the transferred amount transformed into a premium for the life insurance is shown in a seventh column 114, all in the amount of $2500. The cash value build-up of the life insurance policy is shown in an eighth column 116. The GSP percentage, in compliance with the Internal Revenue Code, is set forth in a ninth column 118, resulting in the death benefit amount shown in a tenth column 120. One or more computers are necessary to track the investments, the investment gains, the expenses, the transfers, the premium payments, the GSP percentages and the requirements of the IRC resulting in the death benefit amounts.

In summary, if the annuitant/insured invests $100,000 at age fifty as shown in the chart 100 and dies in his eighty-first year, his life insurance beneficiary receives a death benefit of $150,816, of which $77,500 is used to repay the loan the insured received from the annuity owner ($2500×31 annual loans). The death benefit is tax-free. The annuity beneficiary receives $177,500, of which $100,000 is a return of non-taxable principle, but the remaining $77,500, the yearly net gains loaned and repaid, is now taxable. If the beneficiaries of the annuity and the life insurance policies are the same individual or entity, typically a wife of the annuitant/annuity owner/insured, she receives a total of $250,816 (a net $73,316 from the life insurance policy, a $100,000 return of annuity investment, and a $77,500 loan repayment), and she pays tax on the $77,500 loan repayment only. In comparison, if the product were just the annuity, the wife would receive a non-taxable $100,000 return of annuity investment and a taxable gain of $143,635 from the annuity investment (the yearly $2500 plus interest). The advantage of the inventive annuity/life insurance method and product is the receipt of a net insurance benefit of $73,316; tax free and without further cost to the annuitant/annuity owner/insured.

It is noted that the example illustrated in FIG. 3, assumes a yearly gain because the annuity investment is placed in a 3% bond. However, if the investment is placed in another type of investment or index, such as the S&P 500, there may be no gain in a chosen time period, such as happened during the calendar year 2008. Nevertheless, because the GSP % changes each year as the insured ages, the minimum amount of pure death benefit changes as required by Section 7702 IRC and must be recalculated by the computer to maintain the tax free status of death proceeds from the life insurance policy. It is also noted that there is the annuity investment, and hopefully its periodic gain, and a parallel life insurance investment, and hopefully its periodic gain, after the first premium payment, and both may be tied to the same investment or index, or more likely, to different investments or indexes with different investment rates. All of the changes must be tracked, calculated and reported by the computer.

It is further noted one or both of the annuity investment and the life insurance cash value may be converted to a series of annuity payments at any time if needed to provide a lifetime income stream, preferably converting the annuity first so as to retain the life insurance death benefit as long as possible. If the annuitant/insured dies after age 81, his wife still receives a death benefit even if the annuity has been converted, and if the insured dies before age 81 his beneficiary still receives a death benefit, albeit a lesser amount as shown in the tenth column 120, FIG. 3. Also, if the life insurance beneficiary is not a wife, or if the life insurance policy owner is not the insured, there may be a potential estate tax savings on the $73,316, which is the death benefit of $150,816 minus the $77,500 loan repayment.

It is also noted that an insurance company selling the inventive product may package the product in various ways. For example, each insurance company will have its own profit requirements, its own investment history, its own expense history and the like, so that each company will package a product with some differences. However, the underlying configuration of a product as disclosed herein will have an annuity policy where the gain is removed at predetermined intervals and used to purchase life insurance so that the primary growth in value takes place in the life insurance policy and not in the annuity policy. This construction gives the most favorable tax treatment for the annuity owner, which is the primary objective of annuity owners.

In the alternative, not only may various insurance companies create different packages, but also a different age period may be used in FIG. 3, as may a different initial investment. Additional investments may also be made over the thirty-one-year period, which will increase the net gain of the annuity policy, the amount transferred and the amount paid as a premium. Hence the cash values and death benefits will also increase in accordance with the requirements of the Internal Revenue Code, and again these continuing calculations require monitoring and processing by a computer. It is also understood that different Codes in different countries will result in different calculations through well-known mathematical computations.

As mentioned above, a variation of the present invention includes reducing expenses, fees and charges associated with the life insurance policy by transferring some of these expenses to the expenses, fees and charges associated with the annuity. The advantage of doing so is an improvement in performance of the life insurance policy to the detriment of the annuity policy, but thereby increasing the tax-free death benefit of the life insurance policy while reducing the tax-deferred growth of the annuity policy.

The life insurance purchased may be a single policy or a series of single premium guaranteed issue policies, which are purchased periodically. The deferred annuities are fixed, variable or equity index annuities. Another variation of the present invention is to have the life insurance policy owned by an irrevocable trust resulting in an advantageous saving of estate taxes.

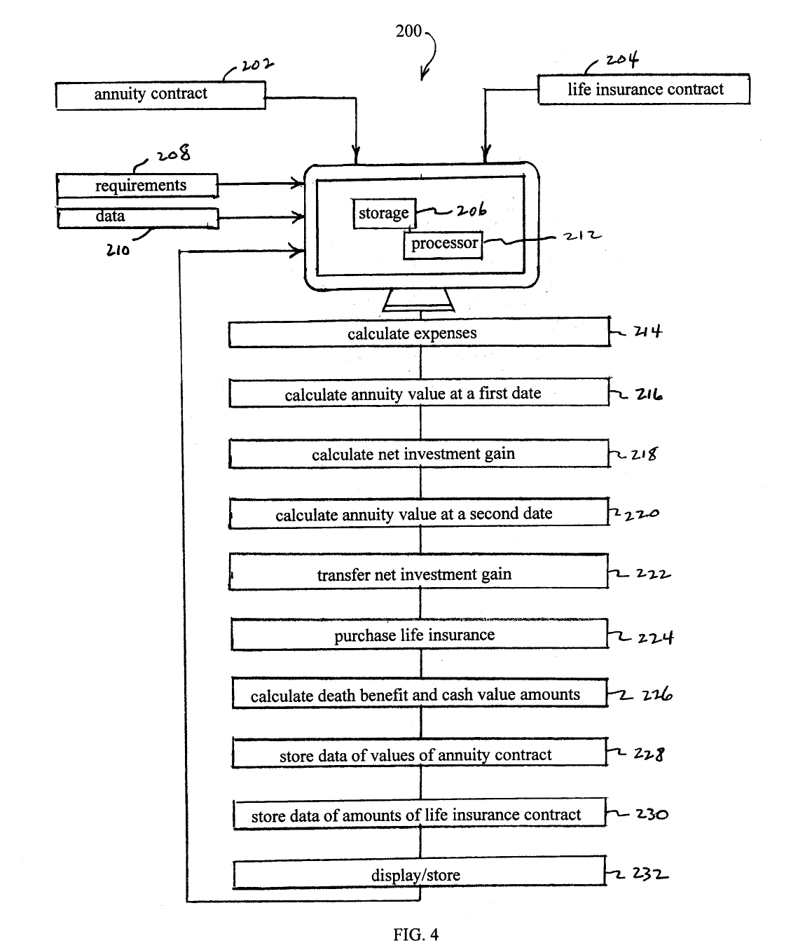

The present invention also includes a data processing system 200, FIG. 4, for processing data associated with a product including the annuity contract 202 and the life insurance contract 204, the data processing system 200 including a storage device 206 for storing requirements 208 relating to a deferred annuity contract and to a universal or variable life insurance contract, and annuity and life insurance data 210 including an annuity owner, an annuity beneficiary, an annuitant, an annuity fund deposit amount, an annuity investment option, an annuity management fee, an investment index, an annuity loan rate, a life insurance contract owner, an insured individual, a life insurance contract beneficiary, a life insurance policy fee, a cost of insurance data, and an annuity investment gain. The data processing system 200 includes a processor 212 in communication with the storage device 206, the processor configured to: calculate expenses attributed to the product 214, calculate a value of the annuity contract at a first predetermined date 216, calculate a net annuity investment gain over a predetermined period 218, calculate a value of the annuity contract at a second predetermined date 220, transfer the net annuity investment gain as a loan from the annuity contract to the life insurance owner 222, and purchase life insurance with the amount of net annuity investment gain 224. Responsive to the purchase of life insurance calculate death benefit and cash value amounts of the insurance contract 226, stores data relating to the values of the annuity contract 228, stores data relating to the amounts of the life insurance contract 230, and displays, prints and/or stores preselected data relating to the annuity values and the insurance amounts 232.

From the foregoing, it can be seen that there has been provided detailed features for a deferred annuity and life insurance product and a disclosure of the method and system for making the product. While particular embodiments of the method and the system have been shown and described in detail, it will be obvious to those skilled in the art that changes and modifications may be made without departing from the present invention in its broader aspects. Therefore, the aim is to cover all such changes and modifications as fall within the true spirit and scope of the claimed invention. The matters set forth in the foregoing description and accompanying drawings are offered by way of illustrations only and not as limitations. The actual scope of the invention is to be defined by the subsequent claims when viewed in their proper perspective based on the prior art.

What is claimed is:

1. A computer implemented method for forming an annuity and life insurance product comprising the steps of:
selecting an annuity policy;
selecting a life insurance policy;
selecting annuity data, including one or more of the following: selecting an annuity fund deposit amount, selecting an annuity owner, selecting an annuity beneficiary, selecting an annuitant, and selecting an annuity investment option;
selecting life insurance data, including selecting a policy owner, selecting an insured individual, and selecting a policy beneficiary;
entering the annuity policy selection, the life insurance policy selection, the annuity data, the life insurance data, and life insurance regulatory requirements into a data processing apparatus, the data processing apparatus having storage, processing and display elements;
calculating investment gains from the annuity policy;
at periodic intervals using the annuity policy investment gains, if any, to purchase the life insurance policy;
at periodic intervals calculating life insurance death benefit and cash value amounts regardless of annuity policy investment gains; and
at periodic intervals displaying the life insurance death benefit and cash value amounts.

2. The method of claim 1, wherein:
selecting the annuity policy step includes selecting a deferred annuity policy.

3. The method of claim 1, wherein:
selecting the life insurance policy step includes selecting a fixed, variable or equity indexed universal life insurance policy.

4. The method of claim 1, including the step of:
loaning the investment gains from the annuity policy, if any, to the life insurance owner to purchase life insurance.

5. The method of claim 1, including the steps of:
selecting life insurance policy fees; and
allocating a disproportionate amount of the life insurance policy fees to the annuity policy.

6. The method of claim 1, wherein:
selecting the annuity policy step includes selecting a deferred annuity policy; and
selecting the life insurance policy step includes selecting a fixed, variable or equity indexed universal life insurance.

7. The method of claim 1, wherein:
selecting the life insurance policy step includes selecting a fixed, variable or equity indexed universal life insurance policy; and including the step of:
loaning the investment gains from the annuity policy, if any, to the life insurance owner to purchase life insurance.

8. The method of claim 1, including the steps of:
loaning the investment gains from the annuity policy, if any, to the life insurance owner to purchase life insurance;
selecting life insurance policy fees; and
allocating a disproportionate amount of life insurance policy fees to the annuity policy.

9. The method of claim 1, wherein:
selecting the annuity policy step includes selecting a deferred annuity policy; and including the step of:
loaning the investment gains from the annuity policy, if any, to the life insurance owner to purchase life insurance.

10. The method of claim 1, wherein:
selecting the life insurance policy step includes selecting a fixed, variable or equity indexed universal life insurance policy; and including the steps of:
selecting life insurance policy fees; and
allocating a disproportionate amount of life insurance policy fees to the annuity policy.

11. The method of claim 1, wherein:
selecting the annuity policy step includes selecting a deferred annuity policy; and including the steps of:
selecting life insurance policy fees; and
allocating a disproportionate amount of life insurance policy fees to the annuity policy.

12. The method of claim 1, wherein:
selecting the annuity policy step includes selecting a deferred annuity policy;
selecting the life insurance policy step includes selecting a fixed, variable or equity indexed universal life insurance policy; and including the steps of:
loaning the investment gains from the annuity policy, if any, to the life insurance owner to purchase life insurance;
selecting life insurance policy fees; and
allocating a disproportionate amount of life insurance policy fees to the annuity policy.

13. A method for forming an annuity and life insurance product comprising the steps of:
selecting an annuity policy;
selecting a life insurance policy;
selecting annuity data, including selecting an annuity fund deposit amount, selecting an annuity owner, selecting an annuity beneficiary, selecting an annuitant, and selecting an annuity investment option;
selecting life insurance data, including selecting a policy owner, selecting an insured individual, and selecting a policy beneficiary;
entering the annuity policy selection, the life insurance policy selection, the annuity data, the life insurance data, insurance company fees and life insurance regulatory requirements into a data processing apparatus, the data processing apparatus having storage, processing and display elements;
calculating investment gains from the annuity policy;
at periodic intervals using the investment gains, if any, to loan funds to the life insurance owner to purchase the life insurance policy;
at periodic intervals calculating life insurance death benefit and cash value amounts regardless of annuity policy investment gain; and
at periodic intervals displaying the life insurance death benefit and cash value amounts.

14. The method of claim 13, wherein:
selecting the annuity policy includes selecting a deferred annuity policy; and
selecting the life insurance policy includes selecting a fixed, variable or equity indexed universal life insurance policy.

15. The method of claim 14, including the steps of:
calculating a net investment gain; and
loaning the net investment gain to the life insurance owner.

16. The method of claim 15, including the step of:
allocating a disproportionate amount of life insurance company fees to the annuity policy.

17. A data processing system for processing data associated with an annuity product including an annuity contract and a life insurance contract, the data processing system comprising:
a storage device for storing data relating to the annuity contract and to the life insurance contract, and annuity and life insurance data including an annuity owner, an annuity beneficiary, an annuitant, an annuity fund deposit amount, an annuity investment option, an annuity management fee, an investment index, an annuity loan rate, an insurance contract owner, an insured individual, an insurance contract beneficiary, a life insurance policy fee, a cost of insurance data, and an annuity investment gain;
a processor in communication with the storage device, the processor configured to:
calculate expenses attributed to the product;
calculate a value of the annuity contract at a first predetermined date;
calculate a net annuity investment gain over a predetermined period;
calculate a value of the annuity contract at a second predetermined date;
transfer the net annuity investment gain, if any, from the annuity contract to the life insurance owner;
purchase life insurance with the amount of net annuity investment gain, if any;
calculate death benefit and cash value amounts of the insurance contract;
store data relating to the values of the annuity contract;
store data relating to the amounts of the life insurance contract; and
display, print and/or store preselected data relating to the annuity values and the insurance amounts.

18. The system of claim 17, wherein:
the annuity contract includes a deferred annuity contract; and
the life insurance contract includes a fixed, variable or equity indexed universal life insurance contract.

19. The system of claim 18, wherein:
the transfer step of the net investment gains from the annuity contract includes loaning the net annuity policy investment gains to the life insurance owner to purchase life insurance.

20. The method of claim 19, wherein:
life insurance contract fees are disproportionally allocated to the annuity policy.
